(19) United States
(12) Patent Application Publication
(10) Pub. No.: US 2024/0268350 A1
(43) Pub. Date: Aug. 15, 2024

(54) PET LEASH

(71) Applicant: XUANLONG ZHU, Nanchong City (CN)

(72) Inventor: XUANLONG ZHU, Nanchong City (CN)

(21) Appl. No.: 18/166,983

(22) Filed: Feb. 9, 2023

(51) Int. Cl. A01K 27/00

(52) U.S. Cl. CPC A01K 27/003

(57) ABSTRACT

The present disclosure provides a pet leash. The pet leash includes a leash body, a handle connected one end of the leash body, and a clasp connected the other end of the leash body. The leash body includes a plurality of leash portions arranged along an extension direction and connected in sequence. The leash portions include at least one first leash portion and at least one second leash portion. The first leash portion includes a first through opening. The second leash portion includes a second through opening. A size of the first through opening is different from a size of the second through opening. Each of the first through opening and the second through opening are configured to hang at least one object.

### FIELD

The present disclosure generally relates to pet supplies, and particularly relates to a pet leash.

### BACKGROUND

Pet ownership is increasing each year, especially pet dogs. Walking your dog outside most certainly requires a leash and is even mandated by many local governments. During dog walking, there are the following needs to be solved: control the dog from running or biting, cleaning up the dog's excrement, drinking water in the middle, etc. Currently, most pet leashes on the market only have the function of restraining the dog, so pet ownership usually need to carry an extra bag, which is troublesome.

Therefore, the design of a more convenient and practical pet leash is the answer to an industry's urgent technical problem.

### SUMMARY

In order to overcome the disadvantage of the existing pet leashes, the present disclosure provides a pet leash which can carry objects easily.

The present disclosure provides a pet leash including: a leash body including a plurality of leash portions arranged along an extension direction and connected in sequence, the leash portions including at least one first leash portion and at least one second leash portion, the first leash portion including a first through opening, the second leash portion including a second through opening, wherein a size of the first through opening is different from a size of the second through opening, and each of the first through opening and the second through opening are configured to hang at least one object; a handle connected one end of the leash body; and a clasp connected the other end of the leash body.

In at least one embodiment, the first leash portion includes a first belt portion and a second belt portion facing the first belt portion, two ends of the first belt portion are connected to two ends of the second belt portion respectively, and the first through opening is located between the first belt portion and the second belt portion.

In at least one embodiment, the second leash portion includes a third belt portion and a fourth belt portion facing the third belt portion, two ends of the third belt portion are connected to two ends of the fourth belt portion respectively, and the second through opening is located between the third belt portion and the fourth belt portion.

In at least one embodiment, the leash portions include a plurality of first leash portions and a plurality of second leash portions, the first leash portions and the second leash portions are disposed alternatively, each first leash portion is connected between two adjacent second leash portions, and each second leash portion is connected between two adjacent first portions.

In at least one embodiment, the two ends of the first belt portion are stitched to the two ends of the second belt portion respectively, the two ends of the third belt portion are stitched to the two ends of the fourth belt portion respectively, an end of the first belt portion, a corresponding end of the second belt portion, an end of the adjacent third belt portion, and an end of the adjacent fourth belt portion are stitched by a first wire, the first wire forms a straight line pattern.

In at least one embodiment, the leash portions include a third leash portion, the third leash portion including a third through opening, a size of the third through opening is different from the size of the first through opening and the size of the second through opening, and the third leash portion is connected between one first leash portion and one second leash portion.

In at least one embodiment, the third leash portion includes a fifth belt portion and a sixth belt portion facing the fifth belt portion, two ends of the fifth belt portion are connected to two ends of the sixth belt portion respectively, and the third through opening is located between the fifth belt portion and the sixth belt portion.

In at least one embodiment, the size of the first through opening is greater than the size of the second through opening, the size of the third through opening is greater than the size of the first leash portion, a length of the first leash portion is greater than the length of the second leash portion, and the length of the third leash portion is greater than the length of the first leash portion.

In at least one embodiment, the leash portions include two first connection portions, one first connection portion is connected between an end of the third leash portion and an end of the first leash portion, and the other connection portion is connected between the other end of third leash portion and an end of the second leash portion.

In at least one embodiment, the leash portions include a second connection portion, the second connection portion is connected between the handle and an end of one first leash portion.

In at least one embodiment, the leash portions include a third connection portion, the third connection portion is connected between one first leash portion away from the handle and one second leash portion away from the handle, the second leash portion away from the handle is connected the clasp.

In at least one embodiment, each of the first connection portion, the second connection portion and the third connection portion includes a seventh belt portion and an eighth belt portion, the first belt portion, the third belt portion, the fifth belt portion, the seventh belt portion are connected to each other and formed by a first piece of belt, the second belt portion, the fourth belt portion, the sixth belt portion, and the eighth belt portion are connected to each other and formed by a second piece of belt.

In at least one embodiment, the handle includes a ninth belt portion and a tenth belt portion connected with and folded towards the ninth belt portion, the first piece of belt, the second piece of belt, the ninth belt portion and the tenth belt portion are formed by one whole belt.

In at least one embodiment, the seventh belt portion and the eighth belt portion are stitched together by patterning wires, and the patterning wires includes a rectangle wire and a mutiplicative shape wire located in the rectangle wire.

The present disclosure provides a pet leash including: a leash body including a plurality of leash portions connected in sequence, at least two leash portions including a through opening respectively, the through openings of the at least two leash portions having different size, and the through openings configured to hang at least one object; a handle connected one end of the leash body; and a clasp connected the other end of the leash body.

The pet leash provided by the present disclosure includes the first through opening and the second through opening having different size from the first through opening, users can hang at least one object or at least two objects with different sizes. There is no need to carry any extra bag, users' experience is improved.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic view of a pet leash according to an embodiment of the present disclosure.

FIG. 2 is an exploded view of the pet leash of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the said features. In the description of embodiments of the invention, “a plurality of” means two or more, unless otherwise specifically defined.

The terms “top”, “bottom”, and other indicating directions or positions are based on the directions or positions shown in the attached drawings in order to facilitate the description of the embodiment and simplify the description of the invention, rather than indicating or implying that the device or element referred to must have a specific orientation, be constructed and operated in a specific orientation, it cannot be understood as a limitation of the embodiment of the invention.

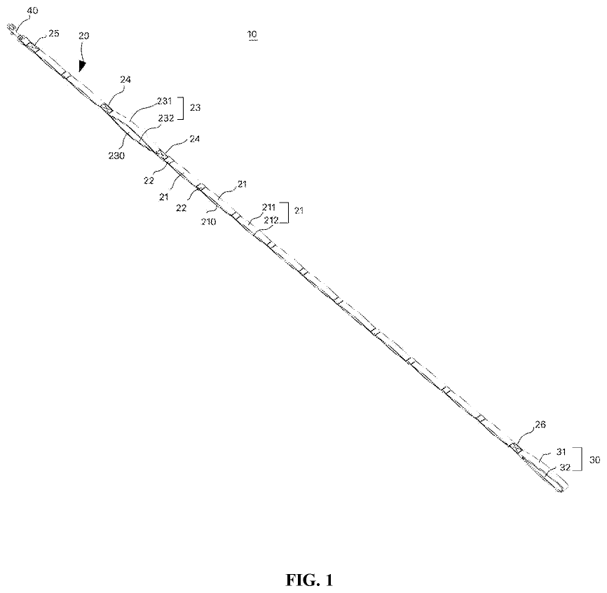

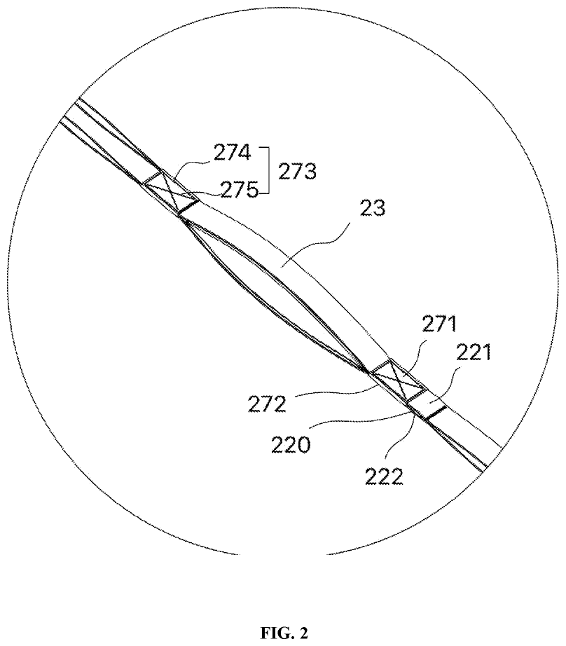

Referring to FIGS. 1-2, an embodiment of the present disclosure provides a pet leash 10. The pet leash 10 includes a leash body 20, a handle 30 and a clasp 40. The handle 30 is connected one end of the leash body 20. The clasp 40 is connected the other end of the leash body 20. The clasp 40 is configured to detachably connected a pet collar.

The leash body 20 includes a plurality of leash portions arranged along an extension direction and connected in sequence. The leash portions include at least one first leash portion 21 and at least one second leash portion 22. The first leash portion 21 includes a first through opening 210, the second leash portion 22 includes a second through opening 220, and a size of the first through opening 210 is different from a size of the second through opening 220. Each of the first through opening 210 and the second through opening 220 are configured to hang at least one object or different objects.

The pet leash 10 provided by the present disclosure includes the first through opening 210 and the second through opening 220 having different size from the first through opening 210, users can hang at least one object or at least two objects with different sizes. There is no need to carry any extra bag, users' experience is improved.

The first leash portion 21 includes a first belt portion 211 and a second belt portion 212 facing with the first belt portion 211, two ends of the first belt portion 211 are connected two ends of the second belt portion 212 respectively, and the first through opening 210 is located between the first belt portion 211 and the second belt portion 212.

The second leash portion 22 includes a third belt portion 221 and a fourth belt portion 222 facing with the third belt portion 221. Two ends of the third belt portion 221 are connected two ends of the fourth belt portion 222 respectively, and the second through opening 220 is located between the third belt portion 221 and the fourth belt portion 222.

The leash portions include a plurality of first leash portions 21 and a plurality of second leash portions 22. The first leash portions 21 and the second leash portions 22 are disposed alternatively. Each first leash portion 21 is connected between two adjacent second leash portions 22, and each second leash portion 22 is connected between two adjacent first portions 21.

The two ends of the first belt portion 211 are stitched to the two ends of the second belt portion 212 respectively, the two ends of the third belt portion 221 are stitched to the two ends of the fourth belt portion 222 respectively. In the embodiment, an end of the first belt portion 211, a corresponding end of the second belt portion 212, an end of the adjacent third belt portion 221, and an end of the adjacent fourth belt portion 222 are stitched by a first wire 223. It can be seen that, the first wire 223 forms a straight line pattern. In other embodiment, the two ends of the first belt portion 211 are glued to the two ends of the second belt portion 212 respectively, and the two ends of the third belt portion 221 are glued to the two ends of the fourth belt portion 222 respectively.

The leash portions include a third leash portion 23. The third leash portion 23 includes a third through opening 230. A size of the third through opening 230 is different from the size of the first through opening 210 and the size of the second through opening 220. The third leash portion 23 is connected between one first leash portion 21 and one second leash portion 22.

The third leash portion 23 includes a fifth belt portion 231 and a sixth belt portion 232 facing with the fifth belt portion 231. Two ends of the fifth belt portion 231 are connected two ends of the sixth belt portion 232 respectively. The third through opening 230 is located between the fifth belt portion 231 and the sixth belt portion 232.

In the embodiment, the size of the first through opening 210 is greater than the size of the second through opening 220, and the size of the third through opening 230 is greater than the size of the first leash portion 220. A length of the first leash portion 21 is greater than the length of the second leash portion 22, and the length of the third leash portion 23 is greater than the length of the first leash portion 21.

The leash portions further includes two first connection portions 24, one first connection portion 24 is connected between an end of the third leash portion 23 and an end of the first leash portion 21, and the other connection portion 24 is connected between the other end of third leash portion 23 and an end of the second leash portion 22.

The leash portions further includes a second connection portion 25, and the second connection portion 25 is connected between the handle 30 and an end of one first leash portion 21.

The leash portions further includes a third connection portion 26, and the third connection portion 26 is connected between one first leash portion 21 away from the handle 30 and one second leash portion 22 away from the handle 30. The second leash portion 22 away from the handle 30 is connected the clasp 40.

Each of the first connection portion 24, the second connection portion 25 and the third connection portion 26 includes a seventh belt portion 271 and an eighth belt portion 272. The first belt portion 211, the third belt portion 221, the fifth belt portion 231, the seventh belt portion 271 are connected to each other and formed by a first piece of belt. The second belt portion 212, the fourth belt portion 222, the sixth belt portion 232, and the eighth belt portion 272 are connected to each other and formed by a second piece of belt.

In the embodiment, the handle 30 a ninth belt portion 31 and a tenth belt portion 32 connected with and folded towards the ninth belt portion 31. The first piece of belt, the second piece of belt, the ninth belt portion 31 and the tenth belt portion 32 are formed by one whole belt.

The seventh belt portion 271 and the eighth belt portion 272 are stitched together by patterning wires 273, and the patterning wires 273 includes a rectangle wire 274 and a mutiplicative shape wire 275 located in the rectangle wire 274.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A pet leash, comprising:
a leash body comprising a plurality of leash portions arranged along an extension direction and connected in sequence, the leash portions comprising at least one first leash portion and at least one second leash portion, the first leash portion comprising a first through opening, the second leash portion comprising a second through opening, wherein a size of the first through opening is different from a size of the second through opening, and each of the first through opening and the second through opening are configured to hang at least one object;
a handle connected one end of the leash body; and
a clasp connected the other end of the leash body.

2. The pet leash according to claim 1, wherein the first leash portion comprises a first belt portion and a second belt portion facing with the first belt portion, two ends of the first belt portion are connected two ends of the second belt portion respectively, and the first through opening is located between the first belt portion and the second belt portion.

3. The pet leash according to claim 2, wherein the second leash portion comprises a third belt portion and a fourth belt portion facing the third belt portion, two ends of the third belt portion are connected two ends of the fourth belt portion respectively, and the second through opening is located between the third belt portion and the fourth belt portion.

4. The pet leash according to claim 3, wherein the leash portions comprise a plurality of first leash portions and a plurality of second leash portions, the first leash portions and the second leash portions are disposed alternatively, each first leash portion is connected between two adjacent second leash portions, and each second leash portion is connected between two adjacent first portions.

5. The pet leash according to claim 4, wherein the two ends of the first belt portion are stitched to the two ends of the second belt portion respectively, the two ends of the third belt portion are stitched to the two ends of the fourth belt portion respectively, an end of the first belt portion, a corresponding end of the second belt portion, an end of the adjacent third belt portion, and an end of the adjacent fourth belt portion are stitched by a first wire.

6. The pet leash according to claim 4, wherein the leash portions comprise a third leash portion, the third leash portion comprising a third through opening, a size of the third through opening is different from the size of the first through opening and the size of the second through opening, and the third leash portion is connected between one first leash portion and one second leash portion.

7. The pet leash according to claim 6, wherein the third leash portion comprises a fifth belt portion and a sixth belt portion facing with the fifth belt portion, two ends of the fifth belt portion are connected two ends of the sixth belt portion respectively, and the third through opening is located between the fifth belt portion and the sixth belt portion.

8. The pet leash according to claim 6, wherein the size of the first through opening is greater than the size of the second through opening, the size of the third through opening is greater than the size of the first leash portion, a length of the first leash portion is greater than the length of the second leash portion, and the length of the third leash portion is greater than the length of the first leash portion.

9. The pet leash according to claim 6, wherein the leash portions comprise two first connection portions, one first connection portion is connected between an end of the third leash portion and an end of the first leash portion, and the other connection portion is connected between the other end of third leash portion and an end of the second leash portion.

10. The pet leash according to claim 9, wherein the leash portions comprise a second connection portion, the second connection portion is connected between the handle and an end of one first leash portion.

11. The pet leash according to claim 10, wherein the leash portions comprise a third connection portion, the third connection portion is connected between one first leash portion away from the handle and one second leash portion away from the handle, the second leash portion away from the handle is connected the clasp.

12. The pet leash according to claim 11, wherein each of the first connection portion, the second connection portion and the third connection portion comprises a seventh belt portion and an eighth belt portion, the first belt portion, the third belt portion, the fifth belt portion, the seventh belt portion are connected to each other and formed by a first piece of belt, the second belt portion, the fourth belt portion, the sixth belt portion, and the eighth belt portion are connected to each other and formed by a second piece of belt.

13. The pet leash according to claim 12, wherein the handle comprises a ninth belt portion and a tenth belt portion connected with and folded towards the ninth belt portion, the first piece of belt, the second piece of belt, the ninth belt portion and the tenth belt portion are formed by one whole belt.

14. The pet leash according to claim 12, wherein the seventh belt portion and the eighth belt portion are stitched together by patterning wires, and the patterning wires includes a rectangle wire and a mutiplicative shape wire located in the rectangle wire.

15. A pet leash, comprising:
a leash body comprising a plurality of leash portions connected in sequence, at least two leash portions comprising a through opening respectively, the through openings of the at least two leash portions having different size, and the through openings configured to hang at least one object;
a handle connected one end of the leash body; and
a clasp connected the other end of the leash body.
